(19) United States
(12) Patent Application Publication
(10) Pub. No.: US 2025/0157106 A1
(43) Pub. Date: May 15, 2025

(54) STYLE TAILORING LATENT DIFFUSION MODELS FOR HUMAN EXPRESSION

(71) Applicant: META PLATFORMS, INC., Menlo Park, CA (US)

(72) Inventors: Arantxa Casanova Paga, Redwood City, CA (US); Bo Sun, Menlo Park, CA (US); Anmol Kalia, Redwood City, CA (US); Amy Lawson Bearman, Emerald Hills, CA (US); Dhruv Kumar Mahajan, Mountain View, CA (US); Animesh Sinha, San Francisco, CA (US)

(21) Appl. No.: 18/942,011

(22) Filed: Nov. 8, 2024

Related U.S. Application Data
(60) Provisional application No. 63/597,483, filed on Nov. 9, 2023.

(51) Int. Cl. G06T 11/60; G06F 3/04845

(52) U.S. Cl. CPC G06T 11/60; G06F 3/04845; G06T 2200/24

(57) ABSTRACT

Aspects of the present disclosure may include systems and methods generating visual content. The system may detect input of descriptive text associated with text content or audio content. The system may generate, based on the descriptive text, an initial latent representation by using a finetuned latent diffusion model. The system may apply a denoising process to the initial latent representation to produce a refined latent representation. The system may sample data points from a content distribution associated with prior timesteps and from a style distribution associated with subsequent timesteps, thereby generating a final image latent. The system may decode the final image latent to obtain a visually aligned image(s) corresponding to the descriptive text. The system may output the visually aligned image(s) on a user interface or a display.

### CROSS-REFERENCE TO RELATED APPLICATIONS

This application claims priority to U.S. Provisional Application No. 63/597,483, filed Nov. 9, 2023, entitled “Text-To-Sticker: Style Tailoring Latent Diffusion Models for Human Expression,” which is incorporated by reference herein in its entirety.

### TECHNOLOGICAL FIELD

Examples of the present disclosure may relate generally to methods, apparatuses and computer program products for utilizing latent diffusion models for visual image enhancement.

### BACKGROUND

There has been a substantial advancement in diffusion-based text-to-image models using natural language descriptions to generate high-quality, visually pleasing images. These models may aim to empower users to conjure up entirely new scenes with unexplored compositions and generate striking images in numerous styles. However, the current methods of fine-tuning these models to accurately reflect intention and specific visual styles may reveal certain challenges.

For example, naively fine-tuning a Latent Diffusion Model (LDM) on a target style often results in a model whose distribution may align with the desired style but at the cost of prompt alignment. There exists a noticeable trade-off between consistently generating prompt-aligned images and consistently generating on-style images. This trade-off highlights the difficulty in simultaneously enhancing prompt alignment, improving visual diversity, and generating visually appealing images that adhere to a particular style. As such, while current finetuning methods may generate a visual output, they have yet to address methods that simultaneously achieve the above-mentioned goals.

### BRIEF SUMMARY

Aspects of the present disclosure may include systems and methods for receiving a descriptive input comprising at least one of a text prompt or an audio prompt, generating, based on the descriptive input, an initial latent representation using a finetuned Latent Diffusion Model, applying a denoising process to the initial latent representation to produce a refined latent representation, sampling data points from a content distribution (p content) for earlier timesteps and from a style distribution (p style) for later timesteps, thereby generating a final image latent, decoding the final image latent to obtain a visually aligned image corresponding to the text prompt, and outputting the visually aligned image on, or by, a user interface.

In additional examples, aspects may include systems and methods finetuning LDMs in a data domain with high visual quality, prompt alignment and scene diversity, and training the LDMs to denoise latents, associated with decoded images, from at least two distributions at a same time, that may be chosen according to timesteps. The systems and methods may also facilitate training the denoised latents with U-Net having data points sampled from a content distribution p content for timesteps closer to a pure noise distribution, and data points sampled from a style distribution p style for timesteps closer to a final image latent.

In one example aspect of the present disclosure, a method is provided. The method may include detecting input of descriptive text associated with at least one of text content or audio content. The method may include generating, based on the descriptive text, an initial latent representation by utilizing a finetuned LDM. The method may include applying a denoising process to the initial latent representation to produce a refined latent representation. The method may include sampling data points associated with a content distribution (p content) associated with prior timesteps and associated with a style distribution (p style) associated with subsequent timesteps, thereby generating a final image latent. The method may include decoding the final image latent to obtain at least one visually aligned image corresponding to the descriptive text. The method may include outputting the at least one visually aligned image on, or by, a user interface or a display.

In another example aspect of the present disclosure, an apparatus is provided. The apparatus may include one or more processors and a memory including computer program code instructions. The memory and computer program code instructions are configured to, with at least one of the processors, cause the apparatus to at least perform operations including detecting input of descriptive text associated with at least one of text content or audio content. The memory and computer program code are also configured to, with the processor(s), cause the apparatus to generate, based on the descriptive text, an initial latent representation by utilizing a finetuned LDM. The memory and computer program code are also configured to, with the processor(s), cause the apparatus to apply a denoising process to the initial latent representation to produce a refined latent representation. The memory and computer program code are also configured to, with the processor(s), cause the apparatus to sample data points associated with a content distribution associated with prior timesteps and associated with a style distribution associated with later timesteps, thereby generating a final image latent. The memory and computer program code are also configured to, with the processor(s), cause the apparatus to decode the final image latent to obtain at least one visually aligned image corresponding to the descriptive text. The memory and computer program code are also configured to, with the processor(s), cause the apparatus to output the at least one visually aligned image on, or by, a user interface or a display.

In yet another example aspect of the present disclosure, a computer program product is provided. The computer program product may include at least one non-transitory computer-readable medium including computer-executable program code instructions stored therein. The computer-executable program code instructions may include program code instructions configured to detect input of descriptive text associated with at least one of text content or audio content. The computer program product may further include program code instructions configured to generate, based on the descriptive text, an initial latent representation by utilizing a finetuned LDM. The computer program product may further include program code instructions configured to apply a denoising process to the initial latent representation to produce a refined latent representation. The computer program product may further include program code instructions configured to sample data points associated with a content distribution associated with prior timesteps and associated with a style distribution associated subsequent timesteps, thereby generating a final image latent. The computer program product may further include program code instructions configured to decode the final image latent to obtain at least one visually aligned image corresponding to the descriptive text. The computer program product may further include program code instructions configured to output the at least one visually aligned image on, or by, a user interface or a display.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the present disclosure; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 illustrates example stickers generated by models in accordance with various aspects of the present disclosure.

FIG. 5 illustrates an example model architecture in accordance with various aspects of the present disclosure.

FIG. 6 illustrates stickers associated with a human-in-the-loop (HITL) alignment dataset in accordance with various aspects of the present disclosure.

FIG. 7 illustrates stickers associated with an experts-in-the-loop (EITL) alignment dataset in accordance with various aspects of the present disclosure.

FIG. 8 illustrates a fine-tuning recipe in accordance with various aspects of the present disclosure.

FIG. 9 illustrates stickers generated from different models, in accordance with various aspects of the present disclosure.

FIG. 10 illustrates Style Tailoring in accordance with various aspects of the present disclosure.

FIG. 11 illustrates a flowchart for generating visual output in accordance with various aspects of the present disclosure.

FIG. 12 illustrates an example of a machine learning framework in accordance with one or more examples of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, a sticker(s) may refer to an image(s) which follows a specific custom style, for example a two-dimensional (2D), or three-dimensional (3D), graphic style with a white border and/or transparent background. Stickers may be digital graphics or illustrations usable to express emotions, messages, personality, and sentiments. Stickers may be applicable to social media posts and other digital content. In some examples, stickers may be static images or animated graphics, and may be usable on various digital media platforms and messaging platforms. A 3D sticker may include additional depth and dimension, as compared to 2D stickers. In some examples, 3D stickers may be animated, may have texture effects, dimensionality, and realism, such as appearing to have greater depth, projecting into or out of a screen (e.g., a display screen). In some examples, stickers may be augmented reality (AR), virtual reality (VR) and/or mixed reality (MR) stickers.

References in this description to “an example”, “one example”, or the like, may mean that the particular feature, function, or characteristic being described is included in at least one example of the present invention. Occurrences of such phrases in this specification do not necessarily all refer to the same example, nor are they necessarily mutually exclusive.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

### Exemplary System Architecture

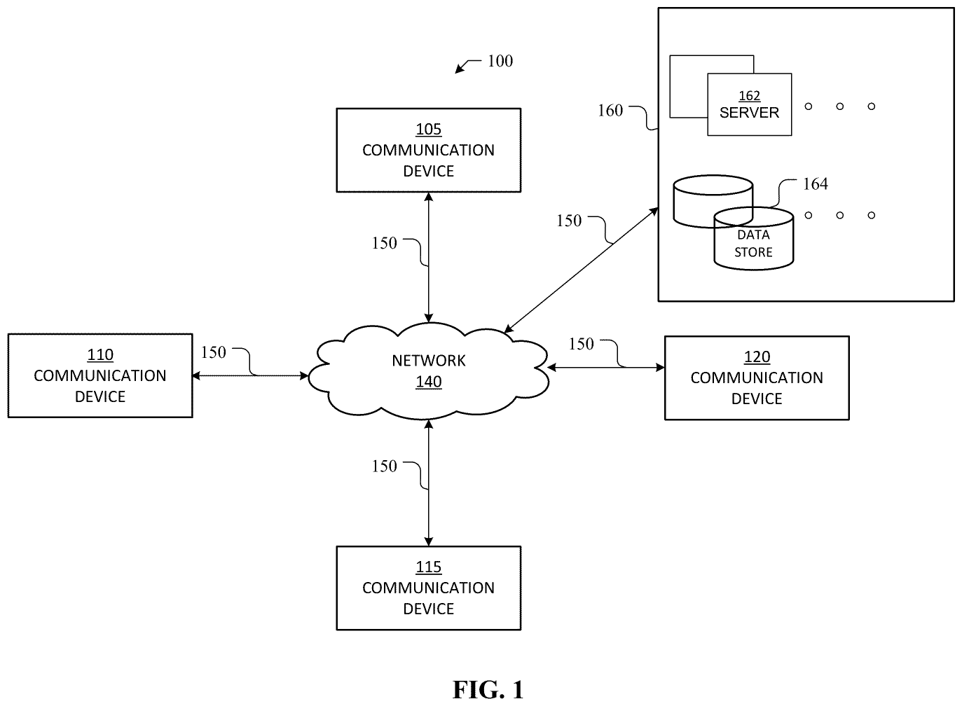

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented reality (AR)/virtual reality (VR) device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

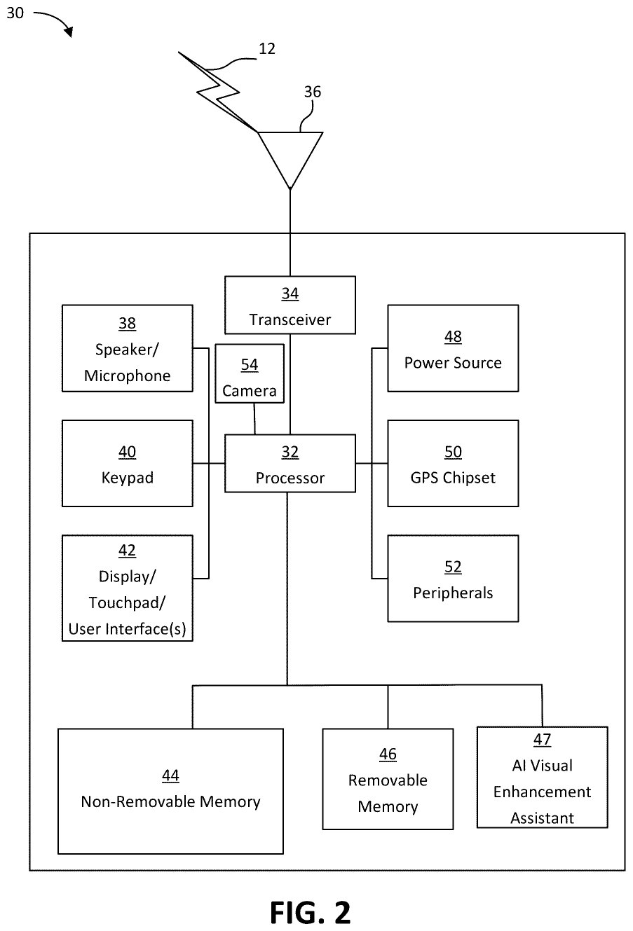

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, a head-mounted display/device (e.g., a headset), smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

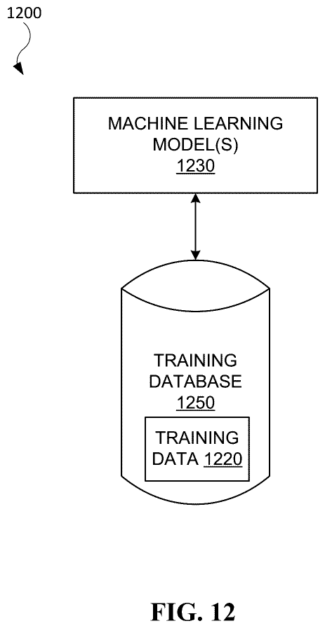

The UE 30 may further include an artificial intelligence (AI) visual enhancement assistant 47 that may finetune LDMs with associated datasets to improve visual quality, prompt alignment and scene diversity (e.g., associated with one or images), as described more fully below. In some examples, the AI visual enhancement assistant 47 may implement a machine learning model (e.g., machine learning model(s) 1230 of FIG. 12) and/or an AI model that may be pre-trained, trained in real-time, and/or periodically trained with training data (e.g., training data 1220 of FIG. 12) to visually enhance one or more images, videos, and/or the like.

### Exemplary Computing System

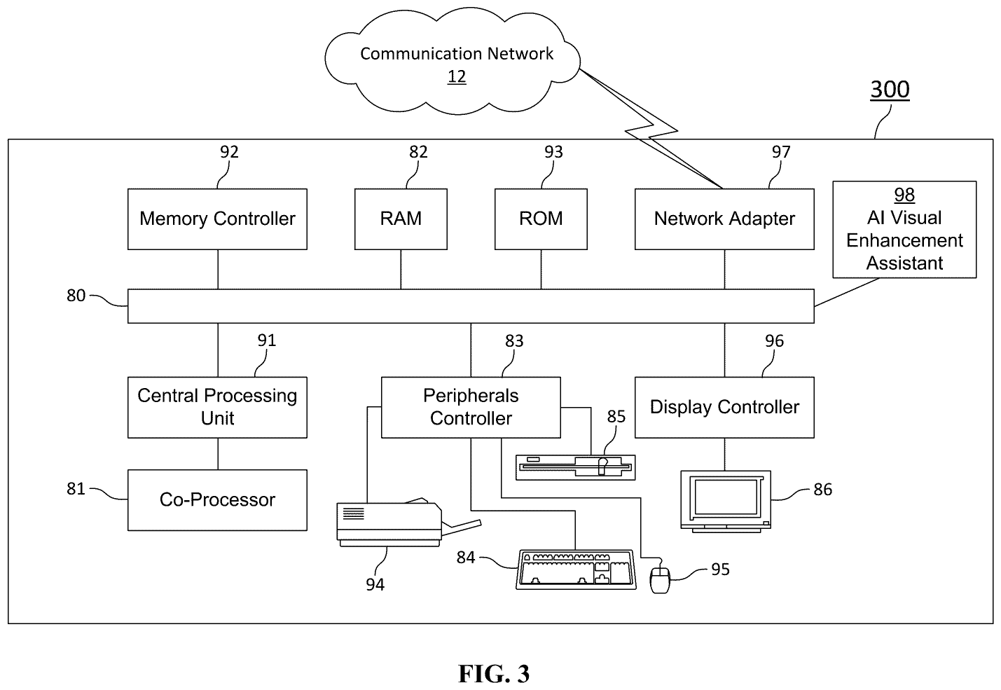

FIG. 3 is a block diagram of an exemplary computing system 300. In some exemplary embodiments, the network device 160 may be a computing system 300. The computing system 300 may include an AI visual enhancement assistant 98. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

The AI visual enhancement assistant 98 may receive one or more requests for content from a device (e.g., from UE 30). In response to receipt of such a request(s) from the device, the AI visual enhancement assistant 98 may generate one or more images, videos and/or the like. In some examples, the AI visual enhancement assistant 98 may facilitate provision of the generated one or more images, videos and/or the like to the device (e.g., UE 30). In some examples, the AI visual enhancement assistant 98 may implement a machine learning model (e.g., machine learning model(s) 1230 of FIG. 12) and/or an AI model that may be pre-trained, trained in real-time, and/or periodically trained with training data (e.g., training data 1220 of FIG. 12) to generate the one or more images, videos and/or the like.

### Exemplary System Operation

Aspects of the present disclosure may relate to LDMs and training methods. In some examples, training methods may improve multiple aspects, including but not limited to (1) enhancing prompt alignment, (2) improving visual diversity, and (3) generating visually appealing images that (4) conform to a particular style. In examples, image sticker generation may be an example application for the proposed systems, methods, and techniques.

In addition, Style Tailoring is introduced, which is a technique to finetune LDMs in a distinct domain with high visual quality, prompt alignment and scene diversity. In examples, a system may choose sticker image generation as the target domain, as the images may significantly differ from photorealistic samples typically generated by large-scale LDMs.

Aspects may start with a state-of-the-art model such as a first language model (e.g., a first large language model) and show that using prompt engineering with the photorealistic model leads to poor prompt alignment and scene diversity. In order to overcome such drawbacks, an example aspect (e.g., AI visual enhancement assistant 47, AI visual enhancement assistant 98) may first finetune the large language model on millions of sticker-like images curated using weak supervision to encourage better prompt alignment and diversity.

The example aspects may then obtain human-in-the-loop (HITL) and Style datasets, aiming to improve prompt alignment and style alignment respectively. Sequential finetuning on both datasets may result in better style alignment but reduced prompt alignment gains. To address this tradeoff, the Style Tailoring fine-tuning method may be introduced (e.g., implemented by the AI visual enhancement assistant 47 or the AI visual enhancement assistant 98) and has been shown, in examples, to improve visual quality by 14%, prompt alignment by 16.2% and scene diversity by 15.3%, compared to applying prompt engineering to a base model for sticker generation. Such techniques may therefore demonstrate how LDMs may be finetuned simultaneously for prompt alignment and visual quality in a specific style domain.

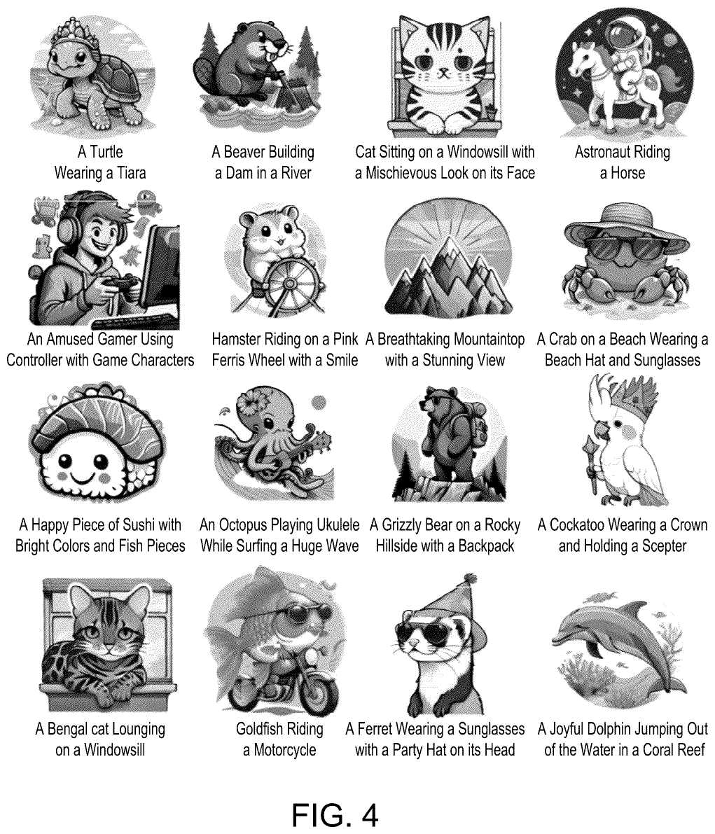

FIG. 4 illustrates example stickers generated by a text-to-sticker model, as discussed herein. Such stickers may be designed with an intention of being visually pleasing, with high text faithfulness and may occur in diverse scenes. The example stickers may be labeled with an example text prompt for generating the sticker.

Example models may include a novel multi-stage fine-tuning approach aimed at optimizing both prompt alignment and visual diversity throughout the fine-tuning process, all while producing visually appealing stickers with a target style. After/in response to a first domain alignment stage with sticker-like data, a system may collect two datasets. First, a Human-in-the-Loop dataset may be applied to improve prompt alignment. This dataset may consist of generated samples from a domain aligned model (e.g., as chosen by human raters according to designed guidelines). Second, the AI visual enhancement assistant 47 or the AI visual enhancement assistant 98 may collect a Style dataset, composed of generated images (e.g., chosen by design experts using an image and/or video model for image or video generation with prompt engineering). This may be called an Experts-in-the-Loop (EITL) step. Finetuning the domain aligned model on EITL data and later on Style data may lead to a tradeoff between style alignment on one hand, and prompt alignment and diversity on the other hand.

Therefore, aspects of the present disclosure may include a novel training method, referred to herein as Style Tailoring, that combines both datasets into one finetuning step, to achieve a better trade-off between prompt and style alignment. In some examples, the Style Tailoring mechanism/technique may be implemented by the AI visual enhancement assistant 47 and/or the AI visual enhancement assistant 98. Style Tailoring may decouple the LDM training objective into two parts: content and style loss. The content loss may be applied to the first few denoising timesteps, to focus on prompt similarity, while the style loss may be applied to the remainder of the timesteps to obtain the desired visual aesthetic. According to various examples, timesteps may be specific stages or discrete points within the denoising process in which each timestep may correspond to a particular noise level in a latent representation. Timesteps may define the path an LDM may take to reduce noise in a latent space, effectively reconstructing and/or generating data. In some examples, timesteps may help to create a sequence for moving from a noisy representation to a denoised representation.

Also incorporated are various systems and methods to achieve, for example, transparency and scene diversity in a pipeline to boost the aesthetics of the generated images further. In some other examples, the approach may be validated by designing a robust human evaluation framework to measure visual quality, prompt alignment and/or scene diversity.

According to various examples, the meticulous selection of exceptionally high-quality images by human experts, guided by well-crafted prompts, may substantially increase visual fidelity. Moreover, the sequence in which fine-tuning steps are executed plays an important role in enhancing both visual quality and prompt alignment. It is also shown that the proposed technique may generalize to more than one target style. Additionally, the proposed methodology may not increase the latency with respect to the base, pre-trained LDM. Generated images (e.g., stickers) may be shown in FIG. 4 based on a model, for example, and quantitatively show improvements on visual quality, prompt alignment and scene diversity compared to prompt engineering associated with the first language model in Table 2, as further discussed below.

Accordingly, systems and methods (e.g., implemented by the AI visual enhancement assistant 47 and/or the AI visual enhancement assistant 98) in accordance with the present disclosure may provide various features and contributions such as a novel training method, which may be referred to herein as Style Tailoring, aimed at obtaining the best trade-off between prompt alignment, scene diversity and visual quality. Style Tailoring may be shown with qualitative examples that this method may generalize to other styles.

Additionally, in some example aspects an extensive study of finetuning techniques may be conducted to attain good performance along the axis of visual quality in a specific style domain, prompt alignment and/or visual diversity. The exemplary aspects of the present disclosure may show the need of the domain alignment finetuning step, as well as the improvements brought by the HITL and Style datasets.

Additional aspects and examples may provide an elegant and effective solution to achieve transparency in generated stickers without introducing any additional latency. The systems and methods discussed herein may further leverage the capabilities of a large language model (LLM) model, a secondary language model (e.g., a secondary large language model), to enrich the scene diversity of the generated images, introducing a novel use for a model (e.g., machine learning model(s) 1230).

Text-to-Image Generation. There has been a tremendous progress in the field of text-to-image generation in recent years. The use of the forward and reverse diffusion process may achieve greater fidelity in image generation compared to Generative Adversarial Networks (GAN). Among diffusion models, Latent Diffusion Models may be more computationally efficient and may be used in various applications, such as reconstructing images from human brain activity, video generation, three-dimensional (3D) environment generation, image editing, controllable generation, and much more. Accordingly, aspects of the present disclosure may focus on finetuning LDMs for a specific domain, such as stickers, and may show their domain alignment capabilities.

Human Preference Alignment. Text-to-image diffusion models may not always generate images that are adequately aligned with the text description and human intent. To improve the alignment between text-to-image models and human preferences, some systems may propose a reward-weighted likelihood maximization based on reward models trained from human feedback. Some other systems may demonstrate existing metrics for generative models having low correlation with human preferences. A dataset of human choices of generated images may be collected, and a Human Preference Score (HPS) for better alignment with human choices may be derived. Other systems may train an ImageReward model using human choices that captures abstractions like aesthetic, body parts, and toxicity/biases. In accordance with various aspects, a human annotation pipeline may be leveraged to filter high-quality generated sticker images, and it may be shown that finetuning solely on high-quality generated data yields significant improvements in visual quality and prompt alignment, and attains a specific sticker style.

Finetuning Text-to-Image Models. Numerous finetuning strategies may also be utilized in pursuit of high-fidelity text-to-image generation. Some systems may introduce new finetuning methods to align the pretrained diffusion models to a specific style, whereas other systems may show high fidelity subject-driven generations using user provided images. Yet other systems may extend the conditioning of diffusion model to image embeddings retrieved by efficient k-nearest neighbors, which may enable generalizing to new distributions at test time by switching a retrieval database. The large language model of the example aspects discussed herein may demonstrate that finetuning with few thousands of high-quality real images may significantly improve the visual quality of the generated images.

“Style-drop” may explore improving compositional power of text-to-image generation models, customizing content and style at the same time by adapter-guided sampling from adapters trained independently from content and style reference images. Accordingly, various example aspects may demonstrate that there is a trade-off between style and text faithfulness during LDM finetuning. As such, a novel finetuning approach is proposed called Style Tailoring, which may be applied to balance such trade-off and optimize for both style and text faithfulness, without adding any components or incurring extra latency at inference.

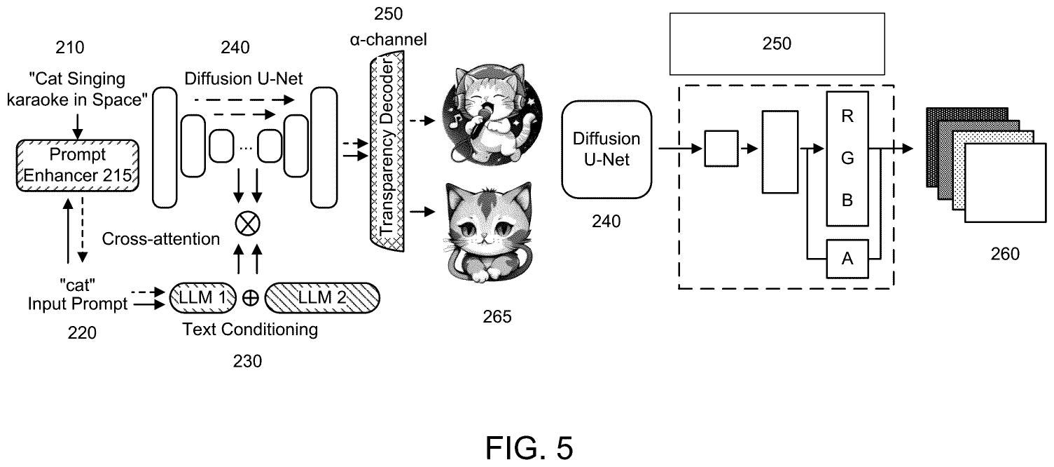

FIG. 5 illustrates an example architecture 200 (also referred to herein as system 200) of a text-to-sticker model (e.g., elements 210, 215, 220, 230, 240, 250, 260) and Transparency Decoder 250. The alpha-channel convolution weights defined by the Transparency Decoder 250 may be initialized with the average of R, G, B channels' weights. In some examples, the Text Conditioning 230 may be a large language model (also referred to herein as LLM 1) and another large language model (also referred to herein as LLM 2). In some examples, the LLM 1 may be a text encoder based model based on contrastive training associated with text inputs and image inputs and may determine text-image pairs. In other examples, the LLM 2 may be a text-to-text based transformer model. The text-to-text based transformer model may map sequences of text. The LLM 1 and the LLM 2 may be kept frozen, e.g., not finetuned.

### Model and Datasets

### Text-to-Sticker Model

FIG. 5 illustrates a text-to-sticker model including (i) a Prompt Enhancer 215, (ii) a Text-guided Diffusion System 240, and (iii) a Transparency Decoder 250. The model output 260 may be sticker images with transparent background (e.g., stickers 265) conditionally generated on input and/or enhanced text prompts.

Prompt Enhancer. In some instances, user input prompts 210 may be detailed (e.g., “cat singing karaoke in space”) and may be simple and abstract (e.g., “love”). The system may create a Prompt Enhancer 215 to generate variations of input prompts (“‘cat’ input Prompt 220), adding more descriptive details without altering its meaning. In view of keeping the pipeline efficient, an instruction (e.g., the user input prompt, text input, etc.) may be finetuned using a first language model (e.g., a first large language model) model to re-phrase the input prompts in the Prompt Enhancer 215. The first large language model may be trained on large amounts of text data for natural language processing tasks, such as for example answering questions, generating content, summarizing text, and/or translation. In some examples, the text-to-sticker model (e.g., machine learning model(s) 1230) may be trained and the instruction may be finetuned. In some examples, the Prompt Enhancer 215 may receive the user input prompt via a user interface (e.g., display/touchpad/user interface(s) 42).

During inference, a secondary language model may be prompted with instructions (several examples of re-phrasing input prompts) and let it improvise another example for the input prompt. As an example, one random re-write of input prompt “love”, may be “a wide-eyed puppy holding a heart.” With Prompt Enhancer 215 and instruction prompting, the system 200 may manage to add a wide range of variations and expressiveness without compromising the fidelity of user intentions.

Text-guided Diffusion System. The text-to-image component(s) may be a standard Latent Diffusion Model, with a trainable parameter U-net architecture (e.g., Diffusion U-Net 240) of the system 200, and may be initialized with the smallest version of the text-to-image model such as the first language model. In other examples, it may be initialized with a third language model (e.g., a third large language model, wherein the third language model is associated with the first language model), which generates images of size 256×256. In some examples, the third large language model may be a text-to-text transformer, and may convert natural language processing tasks to text generation. In some examples of the present disclosure, the third language model may be a second iteration or version of the first language model. In some examples, in Text Conditioning 230, the concatenation of embeddings may be derived using the LLM 1 and the LLM 2. In additional examples, the system 200 may use an alpha-channel autoencoder 250 and/or an 8-channel autoencoder in the text-to-sticker model. Output 260 such as stickers 265 may be generated. In some examples, the text-to-sticker model may be an example of the AI visual enhancement assistant 47 and/or the AI visual enhancement assistant 98.

Transparency System. Real stickers (e.g., stickers 265) may rarely be square, and a transparent background usually makes stickers more visually pleasing. The system 200 may mask the blank space around the generated sticker area with full transparency to create non-square stickers with transparent background. This may be achieved by incrementing, at the Transparency Decoder 250, the output channel of the final convolution layer of the decoder (e.g., output 260 from the Diffusion U-Net) from 3 Red, Green, and Blue (RGB) to 4 Red, Green, Blue, and Alpha (RGBA). By incrementing the output channel and including a new alpha channel in the model prediction, the background of the sticker may become transparent. The weights for the newly added alpha-channel may be initialized as the mean of the weights for RGB channels, and all layers in the Transparency Decoder 250 are finetuned on the dataset discussed with respect to Transparency Decoder 250, while keeping the encoder frozen (e.g., not finetuned). Maintaining a frozen encoder may allow for the replacement of the U-Net (Network) (e.g., trained for a different sticker style) without requiring retraining of the Transparency Decoder 250. In some examples, a U-Net may be a network in a shape of a “U”. This method of generating transparent images in a text-to-image LDM model (e.g., machine learning model(s) 1230) is novel, simple yet efficient. The additional computation may be negligible since the only change may be 3 to 4 channels in the final convolution layer. Since there may be multiple convolutional layers, the last layer may be updated to 4 output channels instead of 3 output channels.

### Datasets

In some example aspects, systems and methods may utilize three separate datasets to train the model (e.g., the text-to-sticker model) such as for example a sticker Domain Alignment (DA) dataset, an HITL alignment dataset, and an EITL style dataset. Images in the DA dataset may be all, or a subset of, real sticker-like images whereas the HITL and EITL datasets may include generated stickers only. There may be a trade-off between consistently generating prompt aligned and style aligned outputs. Hence, there may be a need for two separate datasets that improve prompt alignment and style alignment respectively. Additionally, systems and methods may curate a dataset of stickers with transparency masks to train the transparency decoder (e.g., Transparency Decoder 250). In some examples, these datasets (e.g., the DA dataset, the HITL alignment dataset, the EITL style dataset, the curated dataset of stickers with transparency masks) may be training data (e.g., training data 1220) for the model (e.g. the text-to-sticker model (e.g., machine learning model(s) 1230)).

### Domain Alignment Dataset

In some examples, the system (e.g., system 200) may source a large quantity (e.g., 21 million (M)) of weakly aligned image-text pairs from a set of hashtags (e.g., #stickers, #stickershop, #cutestickers, #cartoon, etc.) corresponding to sticker-like images, then may apply two filtering steps. First, the system may filter out data with low image-text similarity scores by the LLM 1. Second, the system may apply an optical character recognition (OCR) model on the images and filter out images wherein a detected OCR box may be greater than or equal to 8% (e.g., ≥8%) of the image area, to minimize text generated on stickers. Note that this dataset may be obtained primarily for visually aligning with a sticker domain and may not be curated for high image-text alignment.

### HITL Alignment Dataset

The stickers domain dataset may be noisy, and finetuning on the stickers domain dataset alone may not be sufficient to obtain high prompt alignment. To improve the model's prompt alignment, the system (e.g., system 200) may systematically create prompt sets which may cover relevant concepts for sticker generation, e.g., emotions, occupations, actions and activities, etc. Then, the system may generate stickers with the domain aligned model (See, e.g., “Domain Alignment”). In some examples, human annotators may filter the generated stickers for good quality images with high prompt alignment.

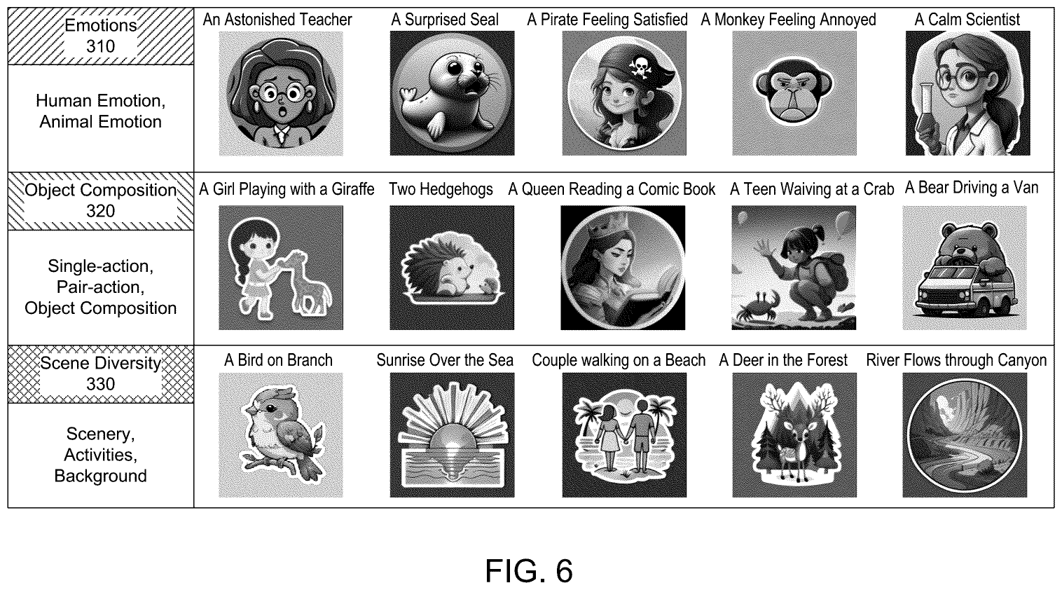

FIG. 6 illustrates stickers from each prompt bucket in an HITL alignment dataset. In some examples, the prompt buckets may be manually created and prepared training data may be provided in, or for, each bucket.

Emotion Expressiveness 310. An Emotions dataset may include human and animal emotions, consisting of nouns (e.g., 8 nouns) which refer to humans (e.g., teen, kids, boy, girl, etc.), occupations (e.g., 22 occupations) (e.g., baker, doctor, lawyer, etc.), and animals (e.g., 83 animals). The system may perform Cartesian products between 36 common emotions and these human/animal concepts to form short phrases with correct grammar as prompts. For example, an angry hippo, a police officer feeling tired. In some examples, Emotion Expressiveness 310 may be referred to herein as Emotions 310.

Object Composition 320. The object composition 320 may include prompts composed by the Cartesian product of aforementioned human/animal concepts with “single-action” and “pair-action”. Here “single-action” may be defined as an action that may be performed by a single object, e.g., a bear drinking coffee or a dog playing frisbee. And “pair-action” may be defined as actions that involves two subjects, e.g., a kid giving a present to a rabbit or a girl playing with a giraffe.

Scene Diversity 330. The system (e.g., system 200) may leverage an instruction finetuned large language model (e.g., a 1.4 billion (B) large language model) to collect prompts that may be hard to be structurally composed by sentence templates, like “landscape” (e.g., river flows down the valley), and “activities” (e.g., family trip). To be noted, a secondary language model here is the same as in the Prompt Enhancer (see, e.g., Text-to-Sticker Model) but the instruction prompting may be different. In Prompt Enhancer, the secondary language model may re-write a given input prompt, but here the prompts may be composed from scratch. In some examples, the input prompt may be provided by a user, such as via a user interface, a keyboard, or other product or peripheral.

For the Emotions 310, Object Composition 320, and Scene Diversity 330 sets, example aspects may generate 5, 5 and 6 images per prompt, respectively (e.g., 5 images for Emotions, 5 images for Scene Diversity, and 6 images for Object Composition). In some examples, human annotators may rate the generated stickers as pass/fail based on guidelines for visual quality (e.g., particularly for faces and body parts) and prompt alignment. The stickers labeled as pass may become the HITL alignment dataset. Details on the pass-rate and number of training images in the HITL alignment dataset are listed in Table 1. Moreover, visual examples from each bucket are shown in FIG. 6.

TABLE 1
Summary of the HITL Alignment dataset. Images may be generated
from a domain aligned model. The images may be filtered by human
annotators for good quality and high prompt alignment.

| Prompt Bucket | Sub-category | #Prompts | Pass-rate | #Images |
|---|---|---|---|---|
| Emotional | Human emotion | 2k | 0.383 | 4.30k |
| expressiveness | Animal emotion | 5k | | |
| Object | Single action | 7.2k | 0.241 | 7.35k |
| composition | Pair action | 8.3k | | |
| Scene diversity | Scenes, activities, | 3.3k | 0.448 | 3.00k |
| | etc. | | | |

### EITL Style Dataset

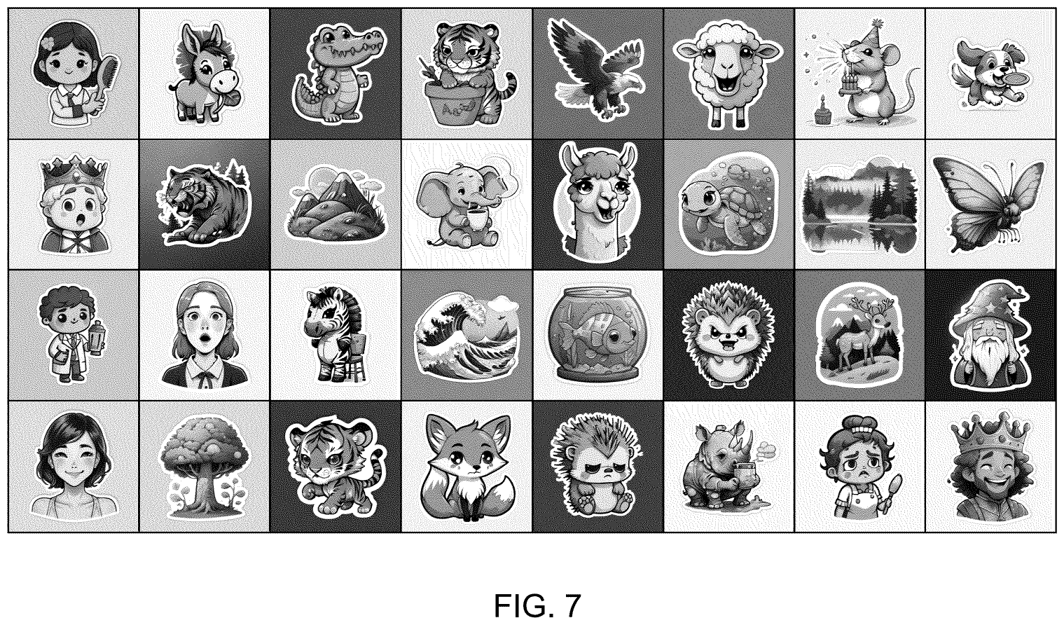

FIG. 7 illustrates stickers from each prompt bucket associated with the EITL style dataset. Besides general visual quality and prompt alignment, it may also be desired to obtain a text-to-sticker model that adheres to a target sticker style criteria (e.g., color, sharpness, linework, layout, shading, etc.). While non-expert human raters may perform well on the task of judging prompt alignment and visual quality, their label quality for the style criteria may be quite low. Instead, it may be determined that design experts are much more reliable in selecting generated stickers with target style. To collect the style dataset, the system (e.g., system 200) may generate stickers using the third language model of the examples of the present disclosure model (e.g., machine learning model(s) 1230) with prompt engineering. The system may choose the third language model for this because it may be determined that, with prompt engineering carefully designed by experts, that the model has the best ability to generate images in the desired style. However, since the third language model may have low prompt alignment as illustrated in Table 2, the system may only be able to collect/obtain data from this model for single subject prompts and may not be able to obtain data for composition prompts. In some examples, a final EITL style dataset may include stickers (e.g., 4,235 stickers) hand curated by design experts, with a few random examples shown in FIG. 7.

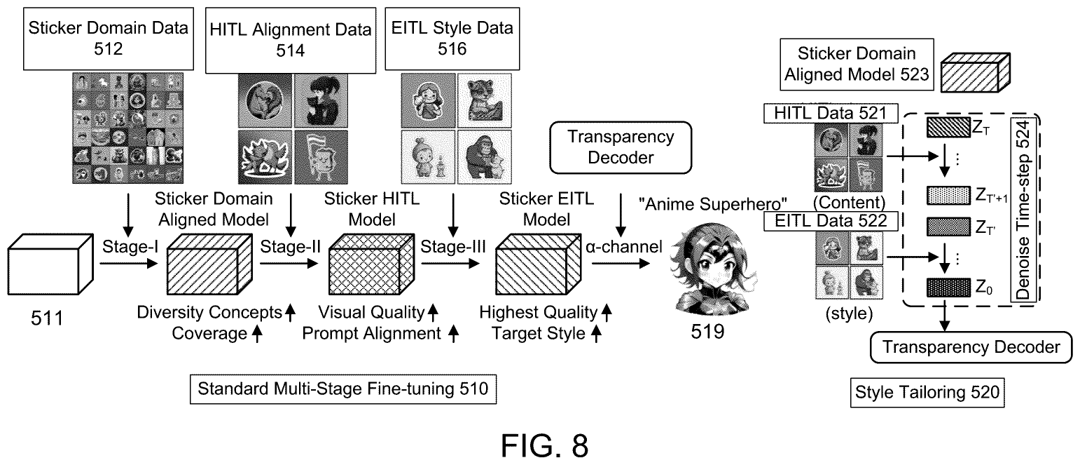

FIG. 8 illustrates a text-to-sticker model finetuning technique, including standard multi-stage fine-tuning 510, and Style Tailoring 520. In Style Tailoring 520, there is implemented a phased dataloader such that the U-Net denoising step T to T′+1 may be trained with HITL alignment data (content distribution p_{content}), and denoising step T′ to 0 may be trained with EITL data (style distribution p_{style}).

The system (e.g., system 200) may curate a dataset of images with transparency masks to train a Transparency Decoder 250 (see, e.g., FIG. 5). First, the system may use a Segment Anything Model to generate foreground masks on a subset of stickers (e.g., 200K stickers) from the domain alignment dataset. Then, the system may refine these masks with a human curation process, that is accelerated given that the annotators may not need to start segmenting from scratch.

In some examples, EITL datasets may be collected with prompt engineering, with the optional assistance of design experts. Some examples of sample stickers may be seen in FIG. 7.

### Multi-Stage Fine-Tuning 510

According to various examples discussed herein, the multi-stage fine-tuning technique may turn the general purpose text-to-image model into a specialized text-to-sticker model. Starting with (i) domain alignment finetuning, followed by (ii) prompt alignment on HITL data and (iii) style alignment on EITL style data. There may be a clear tradeoff between prompt and style alignment, and proposed herein is a novel finetuning method Style Tailoring—the best in-between solution maintaining both prompt and style alignment. In some examples, the Style Tailoring may be implemented/executed by the AI visual enhancement assistant 47 and/or the AI visual enhancement assistant 98.

Training objectives. In all alignment stages, empirically observing finetuning of the full U-Net may yield the best results. The U-Net parameters ϵ_{θ} are updated by optimizing the noise reconstruction objective in all three finetuning stages D∈{Domain Alignment, HITL, EITL} dataset,

$$ℒ ( θ ; ϵ , t ) = {𝔼}_{ϵ \sim 𝒩 ( 0 , 1 )} {}_{( x , y ) \sim 𝒟} ( {‖ ϵ - {ϵ}_{θ} ( ℰ ( x ) , 𝒯 ( y ) ; t ‖}^{2} )$$

Where ϵ denotes the Gaussian noise sample, (x, y) denotes the image-text pair, ε denotes the image autoencoder, T denotes text encoder and t denotes the denoising timesteps.

### Domain Alignment

Relying on prompt engineering to generate stickers with the general text-to-image model (e.g., the third language model) may lead to poor prompt alignment and low scene diversity (details explained in the “Experiments” section). One reason this happens is the first language model and/or the third language model may be finetuned on a small high quality dataset. To spur on diverse sticker generations, the AI visual enhancement assistant may first align the third language model closer to the sticker domain 512 by finetuning with the Domain Alignment dataset, which may include sticker image-text pairs (e.g., 21 M sticker image-text pairs). DA dataset may include diverse stickers (e.g., sticker 519) in assorted styles with loosely aligned captions. It may be determined that the domain alignment finetuning largely improves diversity and weakly improves prompt alignment, and some improvements are quantified in Table 2.

### Prompt Alignment and Style Alignment

To further improve prompt and style alignment, the AI visual enhancement assistant may fine-tune the domain aligned model with the HITL alignment dataset 514 (see also the “HITL Alignment Dataset” section) and the EITL style dataset 516 (see, e.g., the “EITL Style Dataset” section). The HITL alignment dataset 514 has high prompt alignment, and the EITL style dataset 516 includes hand-curated stickers with target style. In the standard multi-stage fine-tuning 510 technique of FIG. 8, the AI visual enhancement assistant may first finetune the domain aligned checkpoint on the HITL dataset for better prompt alignment, and then the AI visual enhancement assistant may bake-in the target style by fine-tuning the HITL checkpoint on EITL style dataset. A clear tradeoff may be noticed between prompt alignment and style alignment. While finetuning on the EITL style dataset may hugely improve style alignment, it may erase some of the prompt alignment gains from HITL. This motivates developing the novel finetuning method called Style Tailoring, which may achieve the best balance between the two objectives, without adding any extra components or latency.

### Style Tailoring 520

In the standard LDM training, the timestep t˜[0, T] is uniformly sampled. A key observation is that when denoising the later timesteps that are closer to the noise sample z_{T}, the model (e.g., machine learning model(s) 1230) may learn to generate the coarser semantics—the content of the image. Additionally, when denoising the earlier timesteps that are closer to the denoised image latent z₀, the model (e.g., machine learning model(s) 1230) learns the fine-grained details—the style of the image.

Different from standard LDM training which denoises latents for decoding images from a single training data distribution p_{data}, in Style Tailoring 520, there is a proposal to train data to denoise latents from two distributions (e.g., HITL data and EITL data) conditioned on timesteps 524. Given a sampled timestep t, the denoising U-Net may be trained with data points sampled from a content distribution p_{content} for timestep t closer to noise t∈[T, T′), and data points sampled from a style distribution p_{style} for timesteps closer to final image latent. In this case, HITL alignment dataset 521 Dₕᵢₜₗ represents the content distribution p_{content}, and EITL style dataset 522 D_{style} represents the style distribution p_{style}. Formally, ∀ϵ∈ [symbol] (0, 1), the joint objective can be provided as

$$\begin{matrix}ℒ ( θ ; ϵ , t ) & = {𝔼}_{t ∈ [ {T}^{′} , T ]} {}_{( x , y ) \sim {𝒟}_{hitl}} ( {‖ ϵ - {ϵ}_{θ} ( ℰ ( x ) , 𝒯 ( y ) ; t ‖}^{2} ) \\ & + {𝔼}_{t ∈ [ 0 , {T}^{′} ]} {}_{( x , y ) \sim {𝒟}_{style}} ( {‖ ϵ - {ϵ}_{θ} ( ℰ ( x ) , 𝒯 ( y ) ; t ‖}^{2} )\end{matrix}$$

The timestep T′ represents the timestep cutoff for using p_{content} or p_{style}. The “Experiments” section may show Style Tailoring offers a superior middle ground, with strong prompt alignment while also generating images that align well with the target style.

### Training Details

Domain Alignment. The example aspects may train the model with global batch size (e.g., 2,240 global batch size) on D_{da} dataset for steps (e.g., 300K steps), using a learning rate (e.g., learning rate 1e-5) with linear warm up followed by a constant schedule. In an example, it may take Graphical Processing Unit (GPU) hours (e.g., around 19,200 A100 GPU hours for stickers domain alignment. The example aspects may use epsilon (eps) parameterization to train the model instead of v. The experiments show that training using eps parameterization led to better body shapes and quality.

Prompt Alignment and Style Alignment. For all subsequent finetuning steps, the exemplary aspects may use a lower learning rate of 5e⁻⁶ and a global batch size of 256. The exemplary aspects may initialize from the domain aligned model and finetune for 8 k steps on Dₕᵢₜₗ for prompt alignment. Once trained, the exemplary aspects may further fine-tune the model (e.g., machine learning model(s) 1230) for 3 k steps on style reference D_{style}. The exemplary aspects may stop early at 3 k steps since the exemplary aspects may observe that the best results may be obtained during the warm-up period with less over-fitting.

Style Tailoring. In Style Tailoring, the model (e.g., machine learning model(s) 1230) may be trained for 5 k steps. The exemplary aspects may empirically set T′=900, which means the 100 timesteps closer to sampled noise may be trained with Dₕᵢₜₗ, and the remaining 900 timesteps may be trained with D_{style}. In each batch, training data points from Dₕᵢₜₗ and D_{style} may be sampled 1:1.

### Evaluation Dataset and Metrics

The exemplary aspects may use a combination of human evaluations and automatic evaluation metrics to understand the performance of the models regarding the (i) visual quality (ii) prompt alignment (iii) style alignment and (iv) scene diversity, of sticker generations.

Evaluation dataset. As an example, for (i) sticker visual quality, a system (e.g., the AI visual enhancement assistant) curated a list of 750 prompts—encompassing daily activities, aspirational phrases, object compositions, etc.—and generated two images per prompt. For (ii) prompt alignment, the system (e.g., the AI visual enhancement assistant) curated 300 hard compositional prompts—100 about emotion expressiveness and 200 about actions and interactions. In this example, ten images may be generated for each prompt. The same seed and starting noise may be used when generating stickers for different models, to ensure accurate and fair comparisons. For (iii) style alignment and (iv) scene diversity, a style reference dataset may be prepared including around 4,150 images. The style reference data may be obtained by the same design experts following the same procedure described associated with the “EITL Style Dataset,” but held-out as a test set. To measure style alignment and scene diversity, the system may generate one image and two images per prompt respectively. The images may then be evaluated for quality and accuracy to the prompt.

Human evaluation. The exemplary aspects may design comprehensive human annotation tasks to measure model performance on an evaluation dataset(s). For (i) visual quality, annotators with a sticker may be presented and ask the annotators to assess whether it meets the guidelines based on nine different criteria—Color, Sharpness, Linework, Detail, Lighting, Centering and Leveling, Flat two-dimensional (2D), Human Faces, and No Text, for example. There may be a collaboration with design experts when designing guideline rubric for each visual axes. For (ii) prompt alignment, raters may be presented with a text-sticker pair and ask the raters to evaluate whether the sticker accurately passes five key aspects—Subject, Quantity, Face & Emotion, Action, and Body Parts. For each annotation job, the exemplary aspects may use three multi-reviews and take their majority vote as the final label.

Automatic evaluation metrics. To measure (iii) style alignment, the system may propose Fréchet Distillation with no labels (DINO) Distance (FDD), with DINOv2 as a feature extractor instead of the conventionally used InceptionV3. InceptionV3 may be trained on ImageNet and has been used to measure Frechet Inception Distance (FID) on other photorealistic benchmarks such as MS-COCO (Common Objects in Context). However, it may perform poorly when generalizing to other out-of-distribution domains, such as stickers. Instead, DINOv2 is a self-supervised method trained with two magnitudes more data and has been shown to generalize better. To measure (iv) scene diversity, the exemplary aspects may use Learned Perceptual Image Patch Similarity (LPIPS) as the perceptual similarity between two generated images given the same prompt. Measuring LPIPS may be standard practice in the conditional image generation community, where higher LPIPS indicates higher scene diversity amongst the generated images given the same conditioning.

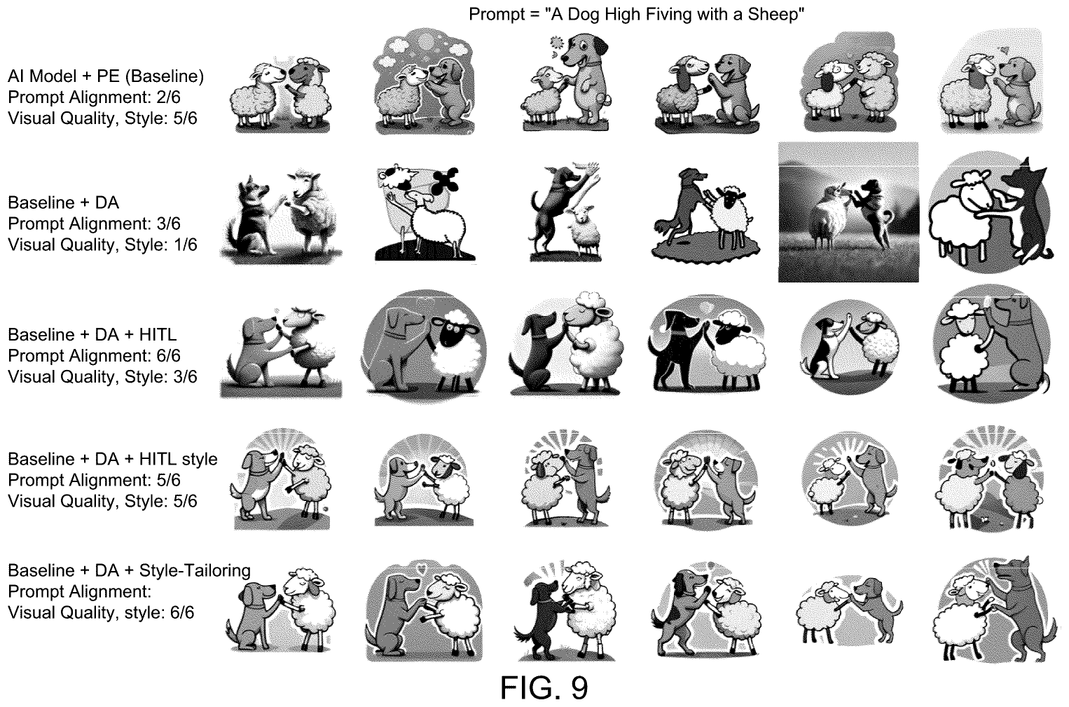

FIG. 9 illustrates visual inspections of the five models with evaluation metrics shown in Table 2. Baseline (R1) may lack prompt alignment and diversity, whereas the domain aligned model (R2) may improve alignment and diversity but may be too low in quality. Multi-stage finetuning (R2→R4) may face a tradeoff between prompt and style alignment. Style Tailoring (R5) offers the best results in both prompt alignment and style alignment. In examples, Row R5 (Style Tailoring) has the best trade-off because its prompt alignment (88.3%) is close to R3 (91.1%), but its style alignment (290.95) is better (e.g., better than the style alignment score 374.29 of R3), as indicated by the lower score. The lower the score the better in regards to style (e.g., style alignment).

TABLE 2
Evaluation results for all models and finetuning techniques. Target Style and Scene Diversity
are measured by automatic metrics FDD and LPIPS respectively. Visual Quality and Prompt
Alignment are measured by human annotation with multi-review = 3. Best results are
shown in bold numbers, second-best results are underlined. The Visual Quality human evaluation
may be omitted for R2, R3 & R4 as they either may be visually deviated too much from target
style or they may be much worse than baselines, due to limited annotation resources.

| | Model | ↓FDD | ↑LPIPS | ↑Quality (%) | ↑Prompt Alignment (%) |
|---|---|---|---|---|---|
| R0 | SDv1-512 + PE | 776.0 | 0.483 | 44.8 | 30.9 |
| R1 | Emu-256 + PE (Baseline) | 168.30 ± 1.20 | 0.469 ± 0.005 | 65.2 | 76 |
| R2 | Baseline + DA | 796.82 ± 5.55 | 0.696 ± 0.002 | — | 82.4 |
| R3 | Baseline + DA + HITL | 374.29 ± 1.54 | 0.570 ± 0.006 | — | 91.1 |
| R4 | Baseline + DA + HITL → Style | 301.10 ± 2.48 | 0.466 ± 0.006 | 75.1 | 85.3 |
| R5 | Baseline + DA + Style-Tailoring | 290.95 ± 2.37 | 0.541 ± 0.001 | 74.3 | 88.3 |

### Experiments

A goal is to train a model which generates visually appealing stickers and are faithful to the text prompt while being in the target visual style. As discussed herein, experiments on a model baseline(s) are shown, as well as analysis of each finetuning stage, results and generalization of style tailoring.

### Baseline

Applying sticker-style prompt engineering (PE) is considered on general purpose text-to-image model as the baseline, PE word choices may be conjugated by design experts. Compared to Stable Diffusion v1 (SDv1-512), the third image generation model has a higher success rate of generating desired sticker style with good quality, therefore the system may use the third language model as the baseline and the foundation model for text-to-sticker. The exemplary aspects may observe two limitations on this third language model+PE baseline—(i) poor prompt alignment (76% pass-rate) and (ii) low scene diversity (0.469 LPIPS), shown in Table 2. The baseline model may generate similar looking subjects and postures, and may fail on compositions for common concepts. Obtaining HITL data directly from this baseline may result in a low diversity dataset and finetuning with the baseline may further reduce diversity. Therefore, the exemplary aspects may finetune the baseline model on Domain Alignment dataset first to uplift the diversity.

### Analysis of Multi-Stage Finetuning

Effectiveness of Domain Alignment. Table 2, Row 2 versus (vs.) Row 1 (R1) shows that Domain Alignment substantially increases scene diversity (LPIPS 0.469→0.696) and moderately increases prompt alignment (76%→82.4%) as well. This meets with expectation since the DA dataset may contain weakly-aligned text-sticker pairs from multiple styles. The downside is that the sticker domain aligned model may move away from the target style (FDD (Frechet Dino Distance) 168.30→796.82, lower better), since the DA dataset includes stickers in mixed quality and style. The exemplary aspects may therefore introduce the subsequent HITL alignment and EITL style finetuning to boost prompt alignment and bring back the target style. Due to the improved prompt alignment of the model (e.g., machine learning model(s) 1230), the exemplary aspects may achieve a higher pass-rate when utilizing the domain-aligned model for obtaining HITL alignment data. As a result, the exemplary aspects may obtain the same amount of data with fewer annotators or in less time, leading to cost savings and more efficient use of resources.

Effect of HITL alignment finetuning. Table 2, R3 vs. R2 shows that finetuning the domain aligned model with HITL dataset largely improves prompt alignment (82.4%→91.1%). The domain aligned model moves closer to the desired style (FDD 796.82→374.29). This is because the annotations guidelines may include criteria for general visual quality. FIG. 9 qualitatively shows the HITL model (3rd row) has much better prompt alignment than baseline (1st row) and domain aligned model (2nd row).

Effect of EITL style finetuning. Table 2, R4 vs. R3 shows that finetuning the HITL model with EITL style dataset further improves the target style alignment (FDD 374.29→301.10). This may be because design experts have higher accuracy labeling according to the style criteria. However, it may be determined that the prompt alignment (91.1%→85.3%) and scene diversity (0.570→0.466) may be reduced when finetuning with the style dataset.

### Style Tailoring: Best Trade-off

Comparing with sequential finetuning (R4), a style-tailored model (R5) improves prompt alignment by +3.5%, scene diversity by +16.2% (LPIPS 0.466→0.541), with superior style alignment (FDD 301.10→290.95, +3.8%) and similar visual quality (75.1%→74.3%, −0.8%). Style Tailoring may offer the best trade-off between all metrics of consideration—prompt alignment, quality, diversity and style. While different models may have the best performance in a single metric, they may all come with significant degradation in other metrics. It is expected that the baseline third language model (R1) has the best style alignment, because the style reference test set is curated from it. Overall, the style-tailored model may obtain second-best results from all perspectives, with close-to-best performance.

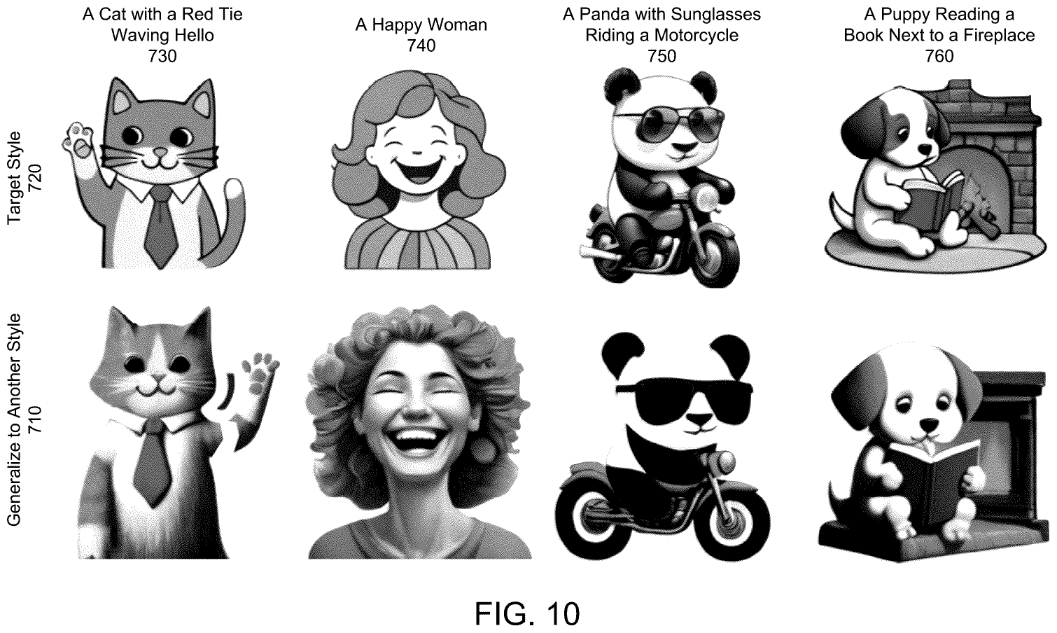

Generalization of Style Tailoring. As an ablation, the AI visual enhancement assistant (e.g., AI visual enhancement assistant 47, AI visual enhancement assistant 98) may curate another style set with a different graphic look and experiment if the proposed Style Tailoring method generalizes to other styles. As shown in FIG. 10, Style Tailoring may generalize to yet another style with high fidelity.

FIG. 10 illustrates style tailoring with the final, target style 720 (top row) an alternate style generalized to a style different than the target 740 (bottom row). FIG. 10 showcases different prompt examples 730, 740, 750, and 760 and the generalization of Style Tailoring to multiple styles.

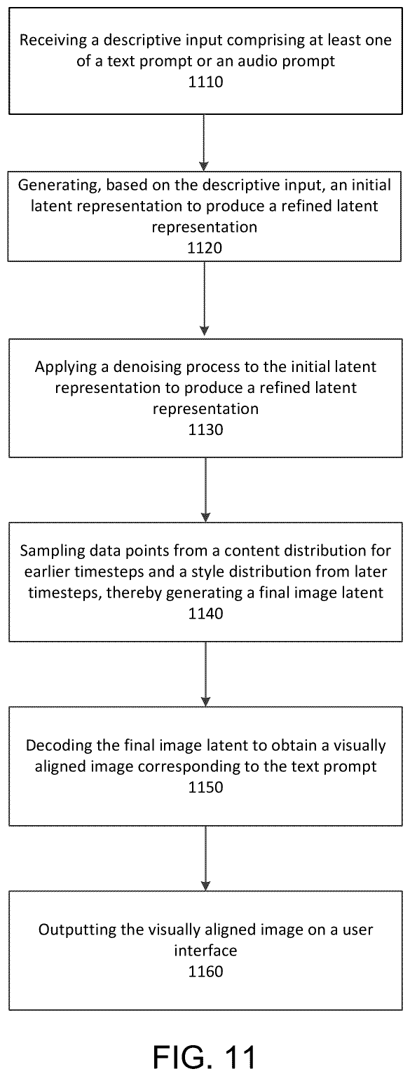

FIG. 11 illustrates a flowchart for generating a visual output in accordance with examples of the present disclosure. At block 1110, a device (e.g., AI visual enhancement assistant 47, AI visual enhancement assistant 98) may receive a descriptive input comprising at least one of a text prompt or an audio prompt. The descriptive input may be received via a user interface (e.g., display/touchpad/user interface 42). In examples, the user interface may include an input field for receiving the text prompt and/or an audio input module for receiving the audio prompt. In some examples, the audio prompt may be captured by a speaker/microphone (e.g., speaker/microphone 38). In another example, the descriptive input may include the audio prompt, and the device may convert the audio prompt to a text format using an automatic speech recognition (ASR) system. The text format may also be processed, for example, by a large language model to generate a mapping to an embedding space.

At block 1120, a device (e.g., AI visual enhancement assistant 47, AI visual enhancement assistant 98) may generate, based on the descriptive input, an initial latent representation by using a finetuned latent diffusion model. In some examples, a latent representation may be a compressed or transformed version of data in which features may be encoded. In some examples, an encoder, such as a pre-trained autoencoder may compress data, such as image data, into a latent representation which may capture features in fewer dimensions. A diffusion process may be applied, which may add and then remove noise within the latent space. In an instance in which the latent representation is generated, a decoder may convert the representation back into a higher dimensional space to produce an output.

The LDM may be trained with at least one of a data domain alignment dataset, a human-in-the-loop alignment dataset, or an expert-in-the-loop style dataset. In additional examples, generating the initial latent representation by using the finetuned LDM may include applying a large language model to map the descriptive input to an embedding space, and the large language model may be trained on at least one dataset comprising at least one of text samples and/or audio samples.

In examples, the LDM may be finetuned in a data domain with high visual quality, prompt alignment and scene diversity. The LDM may also be trained to denoise latents, for example, from at least two distributions (e.g., an HITL dataset, an EITL dataset) at a same time, chosen according to timesteps. The latents may be associated with decoded images. In some examples, the decoded images may be associated with sticker images.

In another example, the descriptive input may include the text prompt, and a large language model may be applied to generate a mapping between a text embedding derived from the descriptive input and a language embedding space. The mapping may also be provided to the finetuned latent diffusion model.

At block 1130, a device (e.g., AI visual enhancement assistant 47, AI visual enhancement assistant 98) may apply a denoising process to the initial latent representation to produce a refined latent representation. In some examples, the denoised latents may be trained with a U-Net model comprising a set of data points sampled from the content distribution (p_content) for timesteps closer to a pure noise distribution, and data points sampled from the style distribution (p_style) for timesteps closer to the final image latent. The denoising process may also include applying the U-Net architecture to iteratively reduce noise from the initial latent representation. The U-Net architecture may be trained on a dataset with varied noise levels and image contents.

At block 1140, a device (e.g., AI visual enhancement assistant 47, AI visual enhancement assistant 98) may sample data points from a content distribution (p content) for earlier/prior timesteps and from a style distribution (p style) for later/subsequent timesteps, thereby generating a final image latent. Sampling data points may utilize a U-Net to process the refined latent representation. The content distribution (p content) and the style distribution (p style) may be learned from a training dataset comprising a plurality of images. The training dataset may include labeled pairs of content and style images.

At block 1150, a device (e.g., AI visual enhancement assistant 47, AI visual enhancement assistant 98) may decode the final image latent to obtain a visually aligned image corresponding to the text prompt. The visually aligned image may be a digital sticker (e.g., an AR image(s), a VR image(s)) applicable for content (e.g., online content (e.g., network content)). The visually aligned image may also be output in multiple formats, including a digital sticker format, depending on an application of the visually aligned image.

At block 1160, a device (e.g., AI visual enhancement assistant 47, AI visual enhancement assistant 98) may output the visually aligned image on, or by, a user interface, display (e.g., display/touchpad/user interface 42) or the like. In other examples, the user interface may be a display associated with a computing system (e.g., computer system 300).

FIG. 12 illustrates an example of a machine learning framework 1200 including machine learning model(s) 1230 and a training database 1250, in accordance with one or more examples of the present disclosure. The training database 1250 may store training data 1220. In some examples, the machine learning framework 1200 may be hosted locally in a computing device or hosted remotely. By utilizing the training data 1220 of the training database 1250, the machine learning framework 1200 may train the machine learning model(s) 1230 to perform one or more functions, described herein, of the machine learning model(s) 1230. In some examples, the machine learning model(s) 1230 may be stored in a computing device. For example, the machine learning model(s) 1230 may be embodied within a communication device (e.g., UE 30). In some other examples, the machine learning model(s) 1230 may be embodied within another device (e.g., computing system 300). Additionally, the machine learning model(s) 1230 may be processed by one or more processors (e.g., processor 32 of FIG. 2, coprocessor 81 of FIG. 3). In some examples, the machine learning model(s) 1230 may be associated with operations (or performing operations) of FIG. 11. In some other examples, the machine learning model(s) 1230 may be associated with other operations. In some examples, the machine learning model(s) 1230 may be an example of the AI visual enhancement assistant 47, and/or the AI visual enhancement assistant 98.

The training data 1220 employed by the machine learning model(s) 1230 may be pre-trained, fixed or updated periodically. Alternatively, the training data 1220 may be updated in real-time based upon the evaluations performed by the machine learning model(s) 1230 in a non-training mode. This may be illustrated by the double-sided arrow connecting the machine learning model(s) 1230 and stored training data 1220 which may be stored in the training database 1250. Some other examples of the training data 1220 may include, but are not limited to, items of content determined as being associated with a network (e.g., the Internet, a social network, etc.), a platform (e.g., system 100) or the like.

For purposes of illustration and not of limitation, for example, the training data 1220 may relate to attributes of objects. For example, the object(s) may be hats, caps, instruments (e.g., pianos), animals, objects, and/or the like. The training data 1220 may be utilized to train the machine learning model(s) 1230 to predict/determine one or more images based on a text prompt(s) (e.g., “A Dog High Fiving with a Sheep” of FIG. 9) and/or audio prompt(s) of a device. The determined one or more images may be output by the machine learning model(s) 1230 for example via a user interface and/or display. Additionally, as described above, the machine learning model(s) 1230 may be trained at an initial stage, in real-time and/or trained periodically (e.g., updated periodically).

In some examples, the machine learning model(s) 1230 may evaluate attributes, such as for example colors, shapes, sizes, numbers, and the like. In some examples, the training data 1220 used for machine learning model(s) 1230 may include, but is not limited to, the training data described above in the Datasets section such as, for example, the DA dataset, the HITL alignment dataset, the EITL style dataset, the curated dataset of stickers with transparency masks and/or the like.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
detecting input of descriptive text associated with at least one of text content or audio content;
generating, based on the descriptive text, an initial latent representation by utilizing a finetuned latent diffusion model (LDM);
applying a denoising process to the initial latent representation to produce a refined latent representation;
sampling data points from a content distribution (p content) associated with prior timesteps and from a style distribution (p style) associated with subsequent timesteps, thereby generating a final image latent;
decoding the final image latent to obtain at least one visually aligned image corresponding to the descriptive text; and
outputting the at least one visually aligned image on, or by, a user interface or a display.

2. The method of claim 1, further comprising:
finetuning the LDM in a data domain with high visual quality, prompt alignment and scene diversity.

3. The method of claim 1, further comprising:
training the LDM to denoise latents, associated with at least two distributions at a same time, chosen according to timesteps.

4. The method of claim 3, wherein the denoised latents are associated with decoded images.

5. The method of claim 3, further comprising:
training the denoised latents with a U-Net comprising a set of data points sampled from the content distribution associated with timesteps closer to a pure noise distribution, and data points sampled from the style distribution associated with timesteps closer to the final image latent.

6. The method of claim 1, further comprising:
outputting the at least one visually aligned image as a digital sticker.

7. The method of claim 1, wherein the denoising process iteratively reduces noise from the initial latent representation.

8. The method of claim 1, wherein the descriptive input includes the text prompt, and further comprising applying a large language model to generate a mapping between a text embedding derived from the descriptive input and a language embedding space; and providing the mapping to the finetuned latent diffusion model.

9. The method of claim 1, wherein the sampling data points comprises utilizing a U-Net to process the refined latent representation.

10. The method of claim 1, further comprising:
training the LDM with at least one of a data domain alignment dataset, a human-in-the-loop alignment dataset, or an expert-in-the-loop style dataset.

11. The method of claim 1, further comprising:
receiving the descriptive text via the user interface, wherein the user interface comprises an input field to receive the text content.

12. An apparatus comprising:
one or more processors; and
at least one memory storing instructions, that when executed by the one or more processors, cause the apparatus to:
detect input of descriptive text associated with at least one of text content or audio content;
generate, based on the descriptive text, an initial latent representation by utilizing a finetuned latent diffusion model (LDM);
apply a denoising process to the initial latent representation to produce a refined latent representation;
sample data points associated with a content distribution (p content) associated with prior timesteps and associated with a style distribution (p style) associated with subsequent timesteps, thereby generating a final image latent;
decode the final image latent to obtain at least one visually aligned image corresponding to the descriptive text; and
output the at least one visually aligned image on, or by, a user interface or a display.

13. The apparatus of claim 12, wherein the at least one visually aligned image is output in multiple formats, comprising a digital sticker format, based on an application associated with the at least one visually aligned image.

14. The apparatus of claim 12, wherein when the one or more processors execute the instructions, the apparatus is configured to:
perform the generate the initial latent representation by utilizing the finetuned LDM by applying a large language model to map the descriptive text to an embedding space, wherein the large language model is trained on a dataset comprising text samples or audio samples.

15. The apparatus of claim 12, wherein when the one or more processors execute the instructions, the apparatus is configured to:
perform the denoising process by applying a U-Net architecture to iteratively reduce noise from the initial latent representation, wherein the U-Net architecture is trained on a dataset with varied noise levels and image content.

16. A non-transitory computer-readable medium comprising instructions that, when executed, cause:
detecting input of descriptive text associated with at least one of text content or audio content;
generating, based on the descriptive text, an initial latent representation by utilizing a finetuned latent diffusion model (LDM);
applying a denoising process to the initial latent representation to produce a refined latent representation;
sampling data points associated with a content distribution (p content) associated with prior timesteps and associated with a style distribution (p style) associated with subsequent timesteps, thereby generating a final image latent;
decoding the final image latent to obtain at least one visually aligned image corresponding to the descriptive text; and
outputting the at least one visually aligned image on, or by, a user interface or a display.

17. The computer-readable medium of claim 16, wherein the content distribution (p content) and the style distribution are learned from a training dataset comprising a plurality of images, wherein the training dataset comprises labeled pairs of content and style images.

18. The computer-readable medium of claim 16, wherein the at least one visually aligned image is output in multiple formats, comprising a digital sticker format, based on an application associated with the at least one visually aligned image.

19. The computer-readable medium of claim 16, wherein the instructions, when executed, further cause:
finetuning the LDM in a data domain with high visual quality, prompt alignment and scene diversity.

20. The computer-readable medium of claim 16, wherein the instructions, when executed, further cause:
training the LDM with at least one of a data domain alignment dataset, a human-in-the-loop alignment dataset, or an expert-in-the-loop style dataset.
